(19) United States
(12) Patent Application Publication
(10) Pub. No.: US 2026/0247113 A1
(43) Pub. Date: Aug. 20, 2026

(54) HYBRID COMMUNICATION SYSTEM AND COMMUNICATION METHOD

(71) Applicant: SHENZHEN TCL NEW TECHNOLOGY CO., LTD., Shenzhen, Guangdong (CN)

(72) Inventor: Ahmed MOHAMMED MIKAEIL SALIH, Shenzhen, Guangdong (CN)

(73) Assignee: SHENZHEN TCL NEW TECHNOLOGY CO., LTD., Shenzhen, Guangdong (CN)

(21) Appl. No.: 19/497,242

(22) PCT Filed: May 23, 2023
(86) PCT No.: PCT/CN2023/095851

§ 371 Date: Dec. 24, 2025

(51) Int. Cl. H04W 4/06

(52) U.S. Cl. CPC H04W 4/06

(57) ABSTRACT

A hybrid communication system and a communication method are disclosed. Further, the hybrid communication system and a user wireless device and a method for unicast, multicast and/or broadcast service data delivery over or reception from one or more content delivery broadcasting systems are disclosed. The hybrid communication system includes a group of network entities interconnected with others to provide interconnections for the delivery one or more content services; and the method is directed to enhancing the data plane and control plane signaling and protocols of the one or more content delivery broadcasting systems for such interconnections and service delivery.

### TECHNICAL FIELD

This invention is related to wireless communication, more specifically related to a hybrid communication system and a communication method, such as reception of broadcast, multicast, and unicast service over different broadcasting access technology.

### BACKGROUND OF DISCLOSURE

In recent years there is a substantial growth in HD video streaming content consumption by network devices such as HDTV sets, smartphones, and tablets via cellular mobile network. To address this potential need, there is a direction to integrate or internetwork different broadcasting technologies such as 3gpp 5G NR multicast and broadcast service (MBS) system with other non-3GPP digital terrestrial TV (DTT) broadcasting technologies such as Digital Video Broadcasting-Terrestrial (DVB-T), Integrated Services Digital Broadcasting (ISDB), Digital Terrestrial Multimedia Broadcast (DTMB), and Advanced Television Systems Committee (ATSC). However, DTT and NR MBS has many differences in terms of system architecture, system design and the service, transport, radio link layer and physical layer user and control plane protocols and signaling.

For example, for DTT user plane, audio and video and broadband services are encapsulated into MDP or DASH segments and delivered to the transport layer in form of a MTS, ROUTE, MMTP, or FLUTE transport session. Then, the transport session is delivered to the radio link layer as ALP, MPE, or GSE protocol units or packets, then these packets are delivered to DTT physical layer which delivers them over a downlink broadcast channel to the user as baseband frame. As for the control plane, DTT uses a set signaling such as a service layer signaling (like USD/USBD, PMT, PAT, CAT, SCA, EIT, NIT in of case DVB) and S-TSID, USD/USBD, MPD, ADP, DWD CNEC, or EME in case of ATSC), transport layer signaling (such as LLS for ATSC and SIT, DIT tables for DVB, a link layer signaling (like LMT and ALP header for ATSC, and LLC table, ALP, MPE, or GSE headers for DVB], and/or physical layer signaling tables and headers to provide the information regarding the service description (i.e., the start, end, and scheduling information of the service, service discovery (i.e., the service identification within a service multiplex), service access (e.g., frequency, channels, and security configuration) to the receiving device.

On the other hand, New radio (NR) MBS delivers audio/video broadcasting services to the receiving device by the means of distributing of object/packet over either MBS session or PDU session, which is then delivered in form of a data or MBS radio bearer (MRB/DRB) using transport link layer protocols like SDAP, PDCP protocols to a lower 5G NR protocol as a form of RLC segments or MAC transport block, which are scheduled using group common radio network identifier (g-RNTI) over group common physical channels to the receiving device. As for NR MBS service, identification, discovery and access or scheduling, an access-based signaling such as RRC signaling, radio link and/or physical layer signaling or a non-access signaling (NAS) is used.

### SUMMARY

### Technical Problem

For the above reasons, internetworking of 5G MBS with non-3GPP DTT networks may require addressing multiple challenges such as introducing new interfaces and network entities and/or enhancing MBS/DTT network architecture to enable interconnecting between the two systems. In addition, in order to support reception of unicast, multicast and broadcast service data from a content delivery server or broadcasting system interconnecting a 5G MBS with and non-3GPP DTT systems, it will also be required to enhance protocol design considering the differences between 5G MBS and DTT systems as discussed above.

This present disclosure proposes a complete system architecture for DTT and MBS internetworking taking into account the above differences.

An object of the present disclosure is to propose a hybrid communication system and a user wireless device and a method for unicast, multicast and/or broadcast service data delivery over or reception from one or more content delivery broadcasting systems such as MBS and DTT systems. The hybrid communication system includes a group of network entities interconnected with others to provide interconnections for the delivery one or more content services; and the method is directed to enhancing the data plane and control plane signaling and protocols of the one or more content delivery broadcasting systems for such interconnections and service delivery.

In a first aspect of the present disclosure, a hybrid communication system comprises: a user wireless device and one or more content delivery broadcasting systems, wherein the hybrid communication system and the user wireless device are configured for unicast, multicast and/or broadcast service data delivery over or reception from the one or more content delivery broadcasting systems, and the hybrid communication system comprises: a joint content delivery network entity interconnected with an enhanced user plane function (UPF) entity and/or a multicast server entity over a first network interface and/or a second network interface; wherein the UPF entity or the multicast server entity is interconnected to an access network entity or to a non-access network entity via a third network interface and/or a fourth network interface; wherein the access network entity or the non-access network entity is linked via a first wireless interface and/or a second wireless interface to a wireless device through an intermediate radio access entity associated with the at least one of the content delivery broadcasting systems.

In some embodiments, the hybrid communication system is configured to execute: multiplexing and/or mapping by at least one network entity, an application layer service data type of a first broadcasting system onto a session type of a second broadcasting system and vice versa, and/or; multiplexing and/or mapping of a session type of a first system onto common or individual tunneling protocol units of a second system and vice versa, and/or; multiplexing and/or mapping of per-session common/individual tunneling protocol data units of the first system onto common or individual radio bearers, transport blocks, radio blocks or forwarding channels of the second system and vice versa.

In some embodiments, the hybrid communication system is configured to execute: providing by the at least one network entity, a signaling information and indication to the wireless device to a next hop network entity towards the wireless device via at least one interface to next hop to assist the network entity or the wireless device to distinguish between the service multiplex and apply a proper forwarding treatment and/or effectively receive the content service multiplex provided by at least one of the content delivery broadcasting systems.

In some embodiments, a first system of the at least one of the content delivery broadcasting systems is a multicast and broadcast service (MBS) broadcasting system, and a second system of the at least one of the content delivery broadcasting systems is a digital terrestrial TV (DTT) broadcasting system and vice versa, wherein the DTT broadcasting system comprises at least one of a digital video broadcasting-terrestrial (DVB-T) system, an integrated services digital broadcasting (ISDB) system, a digital terrestrial multimedia broadcasting (DTMB) system, and/or an advanced television systems committee (ATSC) broadcasting system.

In some embodiments, the application layer service data type of the first broadcasting system or the second broadcasting system is a category and/or indication of a service.

In some embodiments, the category and/or indication of the service is defined in 3GPP MBS, DVB, DTMB and/or ATSC standards.

In some embodiments, the category and/or indication of the service comprises a service identity or temporary mobile group identity (TMGI) of a service in case of the MBS broadcasting system.

In some embodiments, the category and/or indication of the service comprises a service to a category identity mapping in case of the DTT broadcasting system.

In some embodiments, the sessions type of the at least one of the content delivery broadcasting systems comprises an MBS session, a MPEG media transport protocol (MTP) session, a file delivery over unidirectional transport (FLUTE) session, a real-time object delivery over unidirectional transport ROUTE session, a multicast transport session (MTS) session and/or a combination thereof.

In some embodiments, the mapping of per-session common/individual tunneling protocol data units of a first system onto common or individual radio bearers, transport blocks, radio blocks or forwarding channels of a second system, is based on transport, radio link layer and physical layer protocols of the at least one of the content delivery broadcasting systems.

In some embodiments, the signaling information and indication to the wireless device or to the next hop network entity comprises a control plane signaling and/or a header within a user plane that is configured to determine a service within a service multiplex, and/or to provide an access information of a service, and/or to provide a scheduling description of a service.

In some embodiments, the access information of the service comprises a frequency, channels of services, and/or a security configuration for the service; and/or the service description comprises a start, an end and a scheduling information of the service.

In some embodiments, the application layer service data type, the session type and/or the per-session common/individual tunneling protocol data units of the at least one of the content broadcasting systems is configured by the hybrid communication system to be received by the wireless device from the at least one of the content delivery broadcasting systems simultaneously or separately.

In some embodiments, the non-access network entity is an anchor/gateway which terminates and maps a session type of the at least one of the content delivery broadcasting systems to per-session common/individual tunneling protocol data units and is delivered via an IP/IP multicast interface to either a gNodeB Distributed Unit (DU) radio access or a DTT radio access device, or a radio access device capable of employing both a lower layer radio protocol of stacks of the at least one of the content delivery broadcasting systems.

In some embodiments, the access network entity is an enhanced gNode B Centralized Unit (CU) supporting mapping of per-session tunnel protocol data units provided by the enhanced UPF or multicast server via common GTP tunnels onto a radio bearer comprising a common multicast radio bearer (MRB) and/or a common PDCP entity in case of interconnecting with a gNB-DU access, or is mapped to ALP/MPE/GSE/ULE bearers in case of interconnecting with a DTT radio access.

In some embodiments, the radio access entity is an entity employing layer 1 and layer 2 of the at least one of the content delivery broadcasting systems comprising data link layer and physical layer protocols comprising PLP/MPEG-TS/ULE/MPE/GSE-L2 protocol and/or RLC, MAC physical layer protocols, wherein the radio access entity is responsible of framing and transmission of radio bearers, transport blocks, radio blocks of the at least one of the content delivery broadcasting systems.

In some embodiments, the wireless device is a user equipment comprising a linear TV set, an HDTV set, a handset, and/or a tablet device employing a set of either NR RAN or DTT transport, radio link layer and physical layer protocols which allows it to be capable to receive a unicast, multicast or broadcast user data service transmitted/delivered over the at least one of the content delivery broadcasting systems separately or simultaneously.

In some embodiments, a NR transport protocol of the hybrid communication system comprises SDAP and/or PDCP; a radio link layer protocol of the hybrid communication system comprises RLC and/or MAC; and/or physical layer protocols of the hybrid communication system comprise NR PHY protocols and/or PHY protocols.

In some embodiments, DTT transport protocols of the hybrid communication system comprise MTS/ROUTE/MMTP; radio link layer protocols of the hybrid communication system comprise ALP/MPE/GSE/ULE protocols and/or physical layer pipe/MPEG transport streaming/GSE-L2 baseband physical framing protocols.

In a second aspect of the present disclosure, a method according to the hybrid communication system comprising: multiplexing and/or mapping by at least one network entity, an application layer service data type of a first broadcasting system onto a session type of a second broadcasting system and vice versa, and/or; multiplexing and/or mapping of a session type of a first system onto common or individual tunneling protocol units of a second system and vice versa, and/or; multiplexing and/or mapping of per-session common/individual tunneling protocol data units of the first system onto common or individual radio bearers, transport blocks, radio blocks or forwarding channels of the second system and vice versa.

In another aspect of the present disclosure, a communication method comprises: multiplexing and/or mapping by at least one network entity, an application layer service data type of a first broadcasting system onto a session type of a second broadcasting system and vice versa, and/or; multiplexing and/or mapping of a session type of a first system onto common or individual tunneling protocol units of a second system and vice versa, and/or multiplexing and/or mapping of per-session common/individual tunneling protocol data units of the first system onto common or individual radio bearers, transport blocks, radio blocks or forwarding channels of the second system and vice versa.

In some embodiments, the communication method further comprises providing by the at least one network entity, a signaling information and indication to the wireless device to a next hop network entity towards the wireless device via at least one interface to next hop to assist the network entity or the wireless device to distinguish between the service multiplex and apply a proper forwarding treatment and/or effectively receive the content service multiplex provided by at least one of the content delivery broadcasting systems.

In a third aspect of the present disclosure, a non-transitory machine readable storage medium has stored thereon instructions that, when executed by a computer, cause the computer to perform the above method.

In a fourth aspect of the present disclosure, a chip includes a processor, configured to call and run a computer program stored in a memory, to cause a device in which the chip is installed to execute the above method.

In a fifth aspect of the present disclosure, a computer readable storage medium, in which a computer program is stored, causes a computer to execute the above method.

In a sixth aspect of the present disclosure, a computer program product includes a computer program, and the computer program causes a computer to execute the above method.

In a seventh aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a diagram of an example of system architecture for MBS & DTT internetworking according to an embodiment of the present disclosure.

FIG. 2 is a diagram of an example of data plane protocol stack for DTT and MBS internetworking over access/non-access network entity according to an embodiment of the present disclosure.

FIG. 3 is a diagram of an example of data plane protocol stack for DTT and MBS internetworking over an access network Entity according to an embodiment of the present disclosure.

FIG. 4 is a diagram of an example of structure of TMGI used for MBS session according to an embodiment of the present disclosure.

FIG. 5 is a diagram of an example of proposed mapping of DTT service onto MBS session according to an embodiment of the present disclosure.

FIG. 6 is a diagram of an example of GTP-U Header with MBS/DDT session/service indication and Common Tunnel configuration according to an embodiment of the present disclosure.

FIG. 7 is a diagram of an example of data plane protocol stack for DTT and MBS internetworking over non-access network entity according to an embodiment of the present disclosure.

FIG. 8 is a block diagram of a network entity of a hybrid communication system according to an embodiment of the present disclosure.

FIG. 9 is a flowchart illustrating a communication method according to an embodiment of the present disclosure.

FIG. 10 is a block diagram of a system for wireless device according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Internetworking of non-3GPP digital terrestrial TV (DTT) networks and 5G MBS for the purpose of video/audio service or content delivery to terminal equipment can bring many benefits in terms of improving the spectral efficiency, enhancing coverage, and reducing the load in cellular spectrum and the congestion in cellular networks and provide new access/options for DTT over cellular network. However, there is a major difference in system architecture, system design and the service, transport, radio link layer and physical layer data/user plane and control plane protocols between MBS and DTT. Therefore, for these reasons, internetworking of 5G MBS with non-3GPP DTT networks may requires addressing multiple challenges such as introducing new interfaces and network entities and/or enhancing MBS/DTT network architecture to enable interconnecting between the two systems. In addition, in order to support reception of unicast, multicast and broadcast service data from a content delivery server or broadcasting system interconnected with 5G MBS and non-3GPP DTT systems, it will also be required to enhance protocol design considering the differences between 5G MBS and DTT systems as discussed above. This present disclosure proposes a complete system architecture for DTT and MBS internetworking taking into account the above differences.

This disclosure proposed a hybrid communication system and a user wireless device for receiving of unicast, multicast and broadcast service data from different/content delivery or broadcasting systems. The content delivery or broadcasting systems could be either a 5G multicast and broadcast (MBS) system or a digital terrestrial TV (DTT) broadcasting system, in which the DTT system is either a digital video broadcasting (DVB) system, an integrated services digital broadcasting (ISDB) system, a digital terrestrial multimedia broadcasting (DTMB) system, or an advanced television systems committee (ATSC) broadcasting system. In this disclosure, the hybrid communication system is a 5G system or a DTT system in which, a new adaption functions, new interfaces and/or new hybrid radio access devices or a combination of thereof is introduced to help interconnecting and converting of the data plane and control plane protocols and/or the signaling between the two systems (i.e., 5G and a DTT systems). In this system, the data plane and/or control plane protocols of one system are translated a protocol of another system via an access or non-access network entity to allow the wireless device to distinguish and effectively receive a unicast, multicast or broadcast user data service transmitted/delivered or over MBS system or a DTB systems or both simultaneously.

### Embodiments: The Hybrid Communication System

The hybrid communication system comprises, a joint content delivery network entity responsible of multiplexing application layer MBS and DTT user services data onto one or more MBS or DTT sessions, the DTT sessions could be either an MTTP Session, FLUTE session, ROUTE session or MTP session (DVB). Then, delivering the one or more sessions to either an enhanced user plane function (UPF) for DTT and MBS over a F30 interface, which supports MBS and/or DTT sessions delivery over a common tunnel protocol or individual delivery over an individual tunnel protocol to an access network entity via N31 interface or non-access network entity via N30 interface, or to an MBS/DTT media server over a F31 interface, which is capable of delivering MBS and/or DTT sessions over a shared common tunnel or individual tunnel protocol to an access or non-access network entity via N31 interface. On the top of user services data delivery, joint content delivery network entity is also act as a starting point for control plane signaling configuration The hybrid communication system comprises, a joint content delivery network entity responsible of multiplexing application layer MBS and DTT user services data onto one or more MBS or DTT sessions, the DTT sessions could be either an MTTP Session, FLUTE session, ROUTE session or MTP session (DVB). Then, delivering the one or more sessions to either via an enhanced user plane function (UPF) for DTT and MBS over a F30 interface, which supports MBS and/or DTT sessions delivery over a common or individual tunnel protocol to an access network entity via N31 interface or non-access network entity via N30 interface, or to an MBS/DTT media server over a F31 interface, which is capable of delivering MBS and/or DTT sessions over a shared common tunnel or individual tunnel protocol to an access or non-access network entity via N31 interface. The access or non-access network entity is directly or indirectly linked to wireless device over a radio access entity associated with one of the content delivery broadcasting systems via a F20/21 wireless interface.

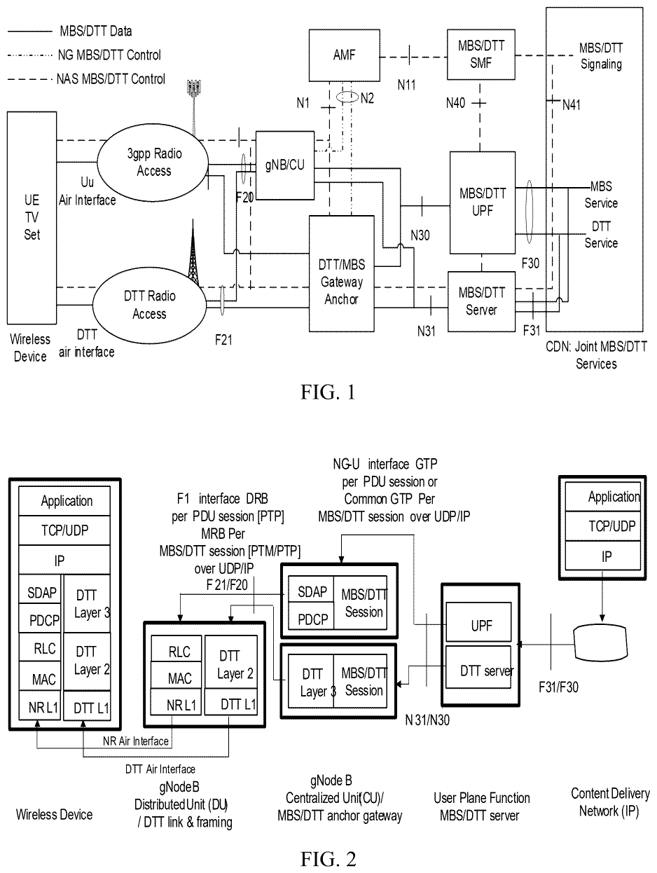

On the top of user services data delivery, joint content delivery network entity is also act as a starting point for control plane signaling configuration which allow the user equipment or the wireless device to receive the service over either MBS/DTT service either over DTT of MBS or both of them simultaneously. The control plane signaling is also used to directly control MBS and DTT service multiplex configuration over the MBS/DTT media server and the enhanced UPF via N40 and N41 respectively, and to control the configuration over the access or non-access network entities using AMF via N11 and N2 interfaces (FIG. 1, FIG. 2) which allow the user equipment or the wireless device to receive the service over either MBS/DTT service either over DTT of MBS or both of them simultaneously. The control plane signaling is also used to directly control MBS and DTT service multiplex configuration over the MBS/DTT media server and the enhanced UPF via N40 and N41 respectively, and to control the configuration over the access or non-access network entities using AMF via N11 and N2 interfaces (FIG. 1, FIG. 2). FIG. 1 shows the system architecture for MBS & DTT internetworking. FIG. 2 shows the data plane protocol stack for DTT and MBS internetworking over access/non-access network entity.

### Embodiment 1: The Non-Access Network Entity

The non-access network entity is an anchor/gateway which terminates and maps a session type of one or more of broadcastings systems to a per-sessions tunnel protocol units and delivered via IP/IP multicast interface to the either a gNodeB Distributed Unit (DU) radio access or DTT radio access device, or an radio access device capable of employing both the lower layer radio protocol of stacks of the one or more broadcasting systems. This entity is responsible of configuration of a common tunnel for MBS/DTT sessions and configuring of an appropriate radio bearer such as a common multicast radio bearer (MRB) and/or a common PDCP entity in case of interconnecting with a gNB-DU access or an appropriate ALP/MPE/GSE/ULE bearer in of interconnecting with a DTT radio access.

### Embodiment 2: The Access Network Entity

The access network entity is an enhanced gNode B Centralized Unit (CU) support mapping of per-sessions tunnel protocol data units provided by the enhanced UPF or multicast server via common GTP tunnels onto a an appropriate radio bearer such as a common multicast radio bearer (MRB) and/or a common PDCP entity in case of interconnecting with a gNB-DU access, or mapping it to an appropriate ALP/MPE/GSE/ULE bearers in case of interconnecting with a DTT radio access.

### Embodiment 3: The Radio Access Entity

The radio access entity is a 3gpp or DTT network access entity employing, either MBS or DTT or DTT and MBS data link layer and physical layer protocols such as PLP/MPEG-TS/ULE/MPE/GSE-L2 and DTT physical baseband framing for DTT or NR physical and radio link layer protocol such as RLC, MAC, and physical layer protocol for 3gpp MBS. This entity is responsible of framing and transmission of MBS/DTT radio bearer and delivering it to the wireless device over a DDT or MBS radio interface.

### Embodiment 4: Wireless Device

Wireless device is a user equipment UE such a linear TV set, HDTV set, handset, tablet device employing a set of either NR RAN or DTT transport, radio link layer and physical layer protocols which allow it to be capable to receive a unicast, multicast or broadcast user data service transmitted/delivered over MBS or DTT broadcasting systems separately or simultaneously. The NR transport protocol are SDAP, PDCP; the radio link layer protocol is RLC, MAC; and physical layer protocols are NR PHY protocols, and PHY protocols. The DTT transport protocols are MTS/ROUTE/MMTP; radio link layer protocols are ALP/MPE/GSE/ULE protocols and: Physical Layer Pipe/MPEG transport streaming/GSE-L2 baseband physical framing protocols.

In the above system, the data and control plane protocol stack of communication system is enhanced, and the wireless device is configured by the hybrid communication system to be able to receive both MBS and/or DTT unicast, multicast and broadcast service over DTT access according to Embodiment 5.

In the above system, the data and control plane protocol stack of communication system is enhanced, and the wireless device is configured by the hybrid communication system to be able to receive both MBS and/or DTT unicast, multicast and broadcast services over MBS access according to Embodiment 6.

### Embodiment 5: Enabling Reception of DTT Service Over MBS Access

For this case the DTT and MBS internetworking is assumed to be over access network entity.

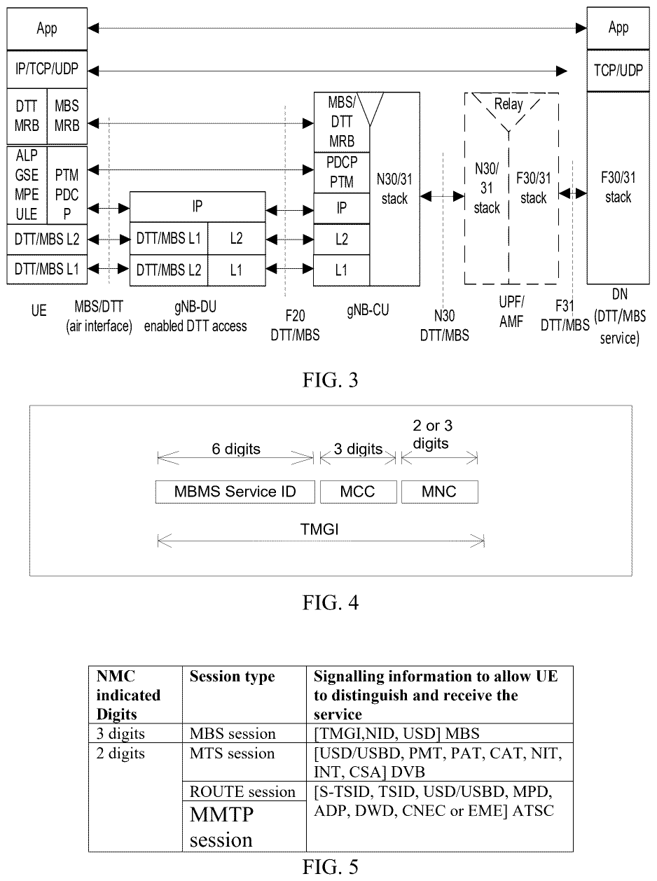

In this case DDT services are mapped onto NR MBS services and multiplexed over MBS session by;1) mapping of DTT services e.g. as defined in DVB or ATSC system onto either an enhanced NR MBS session or newly defined DTT session, 2) mapping of DTT sessions mapping over N30 GTP common tunnel protocol same as MBS session and/or 3) mapping of DTT sessions data content provided over N30GTP common tunnel protocol onto MRB/DRB or common/individual PDCP RLC leg over F20/21 GTP-U tunnels (FIG. 3). FIG. 3 shows the data plane protocol stack for DTT and MBS internetworking over an access network entity.

Option 1: Service Layer-Based Mapping of DTT Services onto MBS Session

As for MBS a Temporary Mobile Group Identity (TMGI) is used to uniquely identify Multicast and Broadcast bearer services. TMGI composes of three parts, 6-digit fixed-length hexadecimal number between 000000 and FFFFFF, three digits Mobile Country Code (MCC) identifies the country where broadcast server or CDN is located, and two or three digits (depending on the assignment to the PLMN by its national numbering plan administrator) identifies the PLMN which the CDN belongs to (with MCC=901 and MNC=56 is used only for services for Receive Only Mode) shown in FIG. 4. FIG. 4 shows the structure of TMGI used for MBS session.

To enable DTT and MBS internetworking and allow UE to receive DTT service over 5G NR MBS access, CDN can maps DTT services into the same MBS services 6-digit number between 000000 and FFFFFF, uses the and enhanced MBS session with DTT signalling information or define a new DTT session type which could be either an MTS, ROUTE or MMTP session to carry DTT service. The Join CDN cloud also uses NMC digit to allow the wireless device to distinguish between these services, for example the reception wireless device may assume that if two NMC digit is provided, the service is DTT service provided over MBS access, otherwise it an MBS service, The indication about service information can be provided using non-access or access signalling to either a next hop network entity or a wireless device to assist the network entity or the wireless device to distinguish between the service multiplex and apply a the proper forwarding treatment and/or effectively receive the content service multiplex provided by hybrid broadcasting system as in this case (FIG. 5). FIG. 5 shows the proposed Mapping of DTT service onto MBS session.

Option 2: Session Based Mapping of DTT Session onto MBS Common Tunnel Data Units:

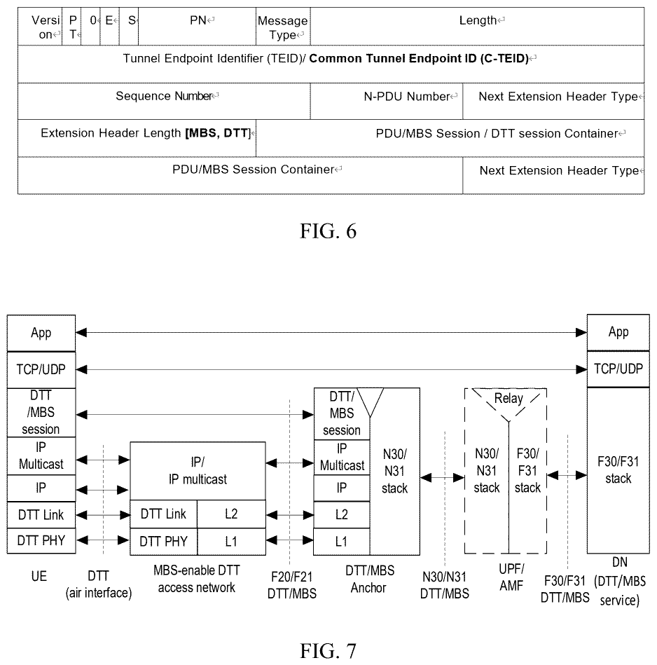

Because DTT session uses different set of transport layer signalling control tables from MBS session as shown in FIG. 5, thus for delivery of DTT services over DTT session from MBS/DTT UPF to gNB-CU, MBS/DTT UPF may use individual MBS traffic delivery (applicable only to multicast MBS sessions) and/or 5GC Shared MBS traffic delivery (applicable to broadcast and multicast MBS sessions). It may also configure a common GTP-U tunnel per DTT session and uses IP multicast transport similar to MBS session with an indicator within GTP header extension field to allow gNB-CU to be able to distinguish between MBS and DTT sessions so that it can configure different transport and link protocol resources for different session (FIG. 6). FIG. 6 shows GTP-U Header with MBS/DDT session/service indication and Common Tunnel configuration.

### Option 3: Radio Bearers-Based Mapping of DTT Common Tunnel Data Units Over MRB/RDB:

In this case DTT sessions data provided over GTP common tunnel protocol could be mapped by gNB-CU onto MRB/DRB radio bearer or onto common or individual PDCP PDU and provided over F20/21 GTP-U tunnels to gNode B distributed (gNB-DU) unit. In case of interconnecting with a gNB-DU access supporting DTT access or a DTT radio access or in case of interconnecting with a DTT radio access unit, there will be a need to define a new MRB to distinguish between an MRB configured for DTT and the other one configured for MBS to allow delivery of DTT session data over the appropriate MBS or DTT bearers.

### Embodiment 6: Enabling Reception of MBS Service Reception Over DTT Access

In this case, the DTT and MBS internetworking is assumed to be over non-access network entity. For this case, the MBS services are mapped into DTT services and multiplexed over DTT session by either 1) Service & Session Based mapping onto DTT session and common tunnel and/or 2) mapping of Transport session content onto DTT L2/L1 protocol units over F21 DTT tunnelling protocol (FIG. 7). FIG. 7 shows the data plane protocol stack for DTT and MBS internetworking over non-access network entity.

Option 1: Service-Based Mapping of MBS Services onto DTT Session

To enable MBS and DTT internetworking and allow UE to receive MBS service over DTT access, a new MBS services type shall be introduced into the DTT service type configuration table (as shown in Table 1 and Table 2 for ATSC and DVB receptively). Additionally, new MBS transport session type shall also be defined with different signalling information table indicating MBS discovery, access configuration (e.g., USD, TMGI, NID), so that if an MBS service is scheduled within a table the MBS session transport shall be used and if not the existing DTT transport session can be used. In this way it is easy to identify and deliver the session from CDN toward the MBS/DTT server and gateway/anchor over N31 and F31 interfaces using IP multicast tunneling protocol such as GRE protocol.

TABLE 1
ATSC session Transport Protocol type

| Transport Protocol | Meaning |
|---|---|
| 0 | ATSC Reserved [MBS session] |
| 1 | ROUTE |
| 2 | MMTP |
| [3] | ATSC Reserved [MBS session] |

TABLE 2
DVB session Transport Protocol type

| Transport Protocol | Meaning |
|---|---|
| 0 | FLUTE Session |
| 1 | ROUTE session |
| 2 | MTS Session |
| 3 | New MBS session] |

TABLE 3
ATSC Service Types and Service Configurations

| Service Category | Service Type |
|---|---|
| 0 | 0 ATSC Reserved |
| 1 | 1 Linear A/V Service |
| 2 | 2 Linear audio only Service |
| 3 | 3 App-Based Service |
| 4 | 4 ESG Service (program guide) |
| 5 | 5 EA Service (emergency alert) |
| 6 | 6 DRM Data Service (DRM Data) |
| 7 Can be used for MBS | Other values ATSC Reserved |

TABLE 4
DVB Service Types and Service Configurations

| Service Category | Service Type |
|---|---|
| Teletext service | (service type 0x03) |
| Mosaic service | (service type 0x06) |
| DVB SRM service | (service type 0x08) |
| Data broadcast service | (service type 0x0C) |
| RCS Map | (service type 0x0E) |
| RCS FLS | (service type 0x0F) |
| DVB MHP service | (service type 0x10) |
| MBS service | (new service type for MBS service) |

### Option 2: Transport Session Content Mapping Over DTT Tunneling Protocol

In this case MBS transport session content provided from MBS/DTT server and/or DTT gateway/anchor over N31/F31 interfaces using IP multicast tunnelling protocol is encapsulated using either ATSC common tunnels protocol of an ALP session data units or as DVB a MPE/GSE/ULE tunnelling data units and forwarded toward the DTT radio access unit over F21 interface. For this case an indication can be provided within the ATSC Link Mapping Table, (LMT), or within DVB Logical Link Control (LLC) or within DVB MPE/GSE/ULE/ALP header to either a next hop network entity or a wireless device to assist the network entity or the wireless device to distinguish between the service multiplex and apply a the proper forwarding treatment and/or effectively receive the content service multiplex provided by hybrid broadcasting system.

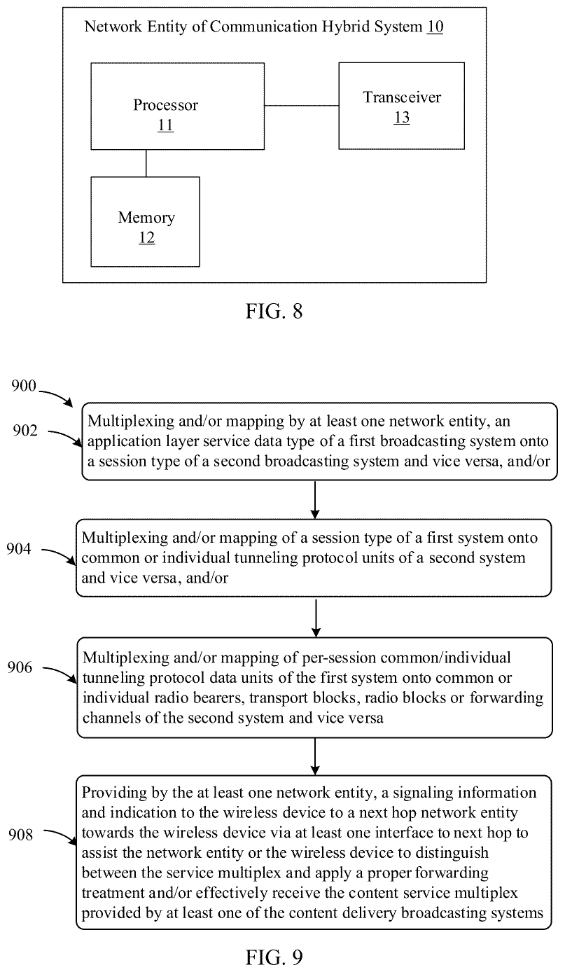

FIG. 8 illustrates that, in some embodiments, a network entity of the hybrid communication system 10 may include a memory 12, a transceiver 13, and a processor 11 coupled to the memory 12 and the transceiver 13. The processor 11 may be configured to implement proposed functions, procedures and/or methods described in this description. Layers of radio interface protocol may be implemented in the processor 11. The memory 12 is operatively coupled with the processor 11 and stores a variety of information to operate the processor 11. The transceiver 13 is operatively coupled with the processor 11, and the transceiver 13 transmits and/or receives a radio signal.

The processor 11 may include application specific integrated circuit (ASIC), other chipset, logic circuit and/or data processing device. The memory 12 may include read only memory (ROM), random access memory (RAM), flash memory, memory card, storage medium and/or other storage device. The transceiver 13 may include baseband circuitry to process radio frequency signals. When the embodiments are implemented in software, the techniques described herein can be implemented with modules (e.g., procedures, functions, and so on) that perform the functions described herein. The modules can be stored in the memory 12 and executed by the processor 11. The memory 12 can be implemented within the processor 11 or external to the processor 11 in which case those can be communicatively coupled to the processor 11 via various means as is known in the art.

In some embodiments, a hybrid communication system comprises: a user wireless device and one or more content delivery broadcasting systems, wherein the hybrid communication system and the user wireless device are configured for unicast, multicast and/or broadcast service data delivery over or reception from the one or more content delivery broadcasting systems, and the hybrid communication system comprises: a joint content delivery network entity interconnected with an enhanced user plane function (UPF) entity and/or a multicast server entity over a first network interface and/or a second network interface; wherein the UPF entity or the multicast server entity is interconnected to an access network entity or to a non-access network entity via a third network interface and/or a fourth network interface; wherein the access network entity or the non-access network entity is linked via a first wireless interface and/or a second wireless interface to a wireless device through an intermediate radio access entity associated with the at least one of the content delivery broadcasting systems.

FIG. 9 illustrates a communication method 900 according to an embodiment of the present disclosure. The method 900 includes an operation 902, multiplexing and/or mapping by at least one network entity, an application layer service data type of a first broadcasting system onto a session type of a second broadcasting system and vice versa, and/or; an operation 904, multiplexing and/or mapping of a session type of a first system onto common or individual tunneling protocol units of a second system and vice versa, and/or; an operation 906, multiplexing and/or mapping of per-session common/individual tunneling protocol data units of the first system onto common or individual radio bearers, transport blocks, radio blocks or forwarding channels of the second system and vice versa, and an operation 908, providing by the at least one network entity, a signaling information and indication to the wireless device to a next hop network entity towards the wireless device via at least one interface to next hop to assist the network entity or the wireless device to distinguish between the service multiplex and apply a proper forwarding treatment and/or effectively receive the content service multiplex provided by at least one of the content delivery broadcasting systems . . . . Further, the processor 11 is configured to perform the above method 900. The processor 11 is also configured to perform the method in the following some embodiments.

Therefore, the hybrid communication system and the user wireless device and the method for unicast, multicast and/or broadcast service data delivery over or reception from the one or more content delivery broadcasting systems are disclosed. The hybrid communication system includes a group of network entities interconnected with others to provide interconnections for the delivery one or more content services, and the method is directed to enhancing the data plane and control plane signaling and protocols of the one or more content delivery broadcasting systems for such interconnections and service delivery.

In some embodiments, a first system of the at least one of the content delivery broadcasting systems is a multicast and broadcast service (MBS) broadcasting system, and a second system of the at least one of the content delivery broadcasting systems is a digital terrestrial TV (DTT) broadcasting system and vice versa, wherein the DTT broadcasting system comprises at least one of a digital video broadcasting-terrestrial (DVB-T) system, an integrated services digital broadcasting (ISDB) system, a digital terrestrial multimedia broadcasting (DTMB) system, and/or an advanced television systems committee (ATSC) broadcasting system. This can enhance the data plane and control plane signaling and protocols of the one or more content delivery broadcasting systems for such interconnections and service delivery.

In some embodiments, the application layer service data type of the first broadcasting system or the second broadcasting system is a category and/or indication of a service. In some embodiments, the category and/or indication of the service is defined in 3GPP MBS, DVB, DTMB and/or ATSC standards. In some embodiments, the category and/or indication of the service comprises a service identity or temporary mobile group identity (TMGI) of a service in case of the MBS broadcasting system. In some embodiments, the category and/or indication of the service comprises a service to a category identity mapping in case of the DTT broadcasting system. This can enhance the data plane and control plane signaling and protocols of the one or more content delivery broadcasting systems for such interconnections and service delivery.

In some embodiments, the sessions type of the at least one of the content delivery broadcasting systems comprises an MBS session, a MPEG media transport protocol (MTP) session, a file delivery over unidirectional transport (FLUTE) session, a real-time object delivery over unidirectional transport ROUTE session, a multicast transport session (MTS) session and/or a combination thereof. This can enhance the data plane and control plane signaling and protocols of the one or more content delivery broadcasting systems for such interconnections and service delivery.

In some embodiments, the mapping of per-session common/individual tunneling protocol data units of a first system onto common or individual radio bearers, transport blocks, radio blocks or forwarding channels of a second system, is based on transport, radio link layer and physical layer protocols of the at least one of the content delivery broadcasting systems. This can enhance the data plane and control plane signaling and protocols of the one or more content delivery broadcasting systems for such interconnections and service delivery.

In some embodiments, the signaling information and indication to the wireless device or to the next hop network entity comprises a control plane signaling and/or a header within a user plane that is configured to determine a service within a service multiplex, and/or to provide an access information of a service, and/or to provide a scheduling description of a service. In some embodiments, the access information of the service comprises a frequency, channels of services, and/or a security configuration for the service; and/or the service description comprises a start, an end and a scheduling information of the service. This can enhance the data plane and control plane signaling and protocols of the one or more content delivery broadcasting systems for such interconnections and service delivery.

In some embodiments, the application layer service data type, the session type and/or the per-session common/individual tunneling protocol data units of the at least one of the content broadcasting systems is configured by the hybrid communication system to be received by the wireless device from the at least one of the content delivery broadcasting systems simultaneously or separately. This can enhance the data plane and control plane signaling and protocols of the one or more content delivery broadcasting systems for such interconnections and service delivery.

In some embodiments, the non-access network entity is an anchor/gateway which terminates and maps a session type of the at least one of the content delivery broadcasting systems to per-session common/individual tunneling protocol data units and is delivered via an IP/IP multicast interface to either a gNodeB Distributed Unit (DU) radio access or a DTT radio access device, or a radio access device capable of employing both a lower layer radio protocol of stacks of the at least one of the content delivery broadcasting systems. This can enhance the data plane and control plane signaling and protocols of the one or more content delivery broadcasting systems for such interconnections and service delivery.

In some embodiments, the access network entity is an enhanced gNode B Centralized Unit (CU) supporting mapping of per-session tunnel protocol data units provided by the enhanced UPF or multicast server via common GTP tunnels onto a radio bearer comprising a common multicast radio bearer (MRB) and/or a common PDCP entity in case of interconnecting with a gNB-DU access, or is mapped to ALP/MPE/GSE/ULE bearers in case of interconnecting with a DTT radio access. This can enhance the data plane and control plane signaling and protocols of the one or more content delivery broadcasting systems for such interconnections and service delivery.

In some embodiments, the radio access entity is an entity employing layer 1 and layer 2 of the at least one of the content delivery broadcasting systems comprising data link layer and physical layer protocols comprising PLP/MPEG-TS/ULE/MPE/GSE-L2 protocol and/or RLC, MAC physical layer protocols, wherein the radio access entity is responsible of framing and transmission of radio bearers, transport blocks, radio blocks of the at least one of the content delivery broadcasting systems. This can enhance the data plane and control plane signaling and protocols of the one or more content delivery broadcasting systems for such interconnections and service delivery.

In some embodiments, the wireless device is a user equipment comprising a linear TV set, an HDTV set, a handset, and/or a tablet device employing a set of either NR RAN or DTT transport, radio link layer and physical layer protocols which allows it to be capable to receive a unicast, multicast or broadcast user data service transmitted/delivered over the at least one of the content delivery broadcasting systems separately or simultaneously. This can enhance the data plane and control plane signaling and protocols of the one or more content delivery broadcasting systems for such interconnections and service delivery.

In some embodiments, a NR transport protocol of the hybrid communication system comprises SDAP and/or PDCP; a radio link layer protocol of the hybrid communication system comprises RLC and/or MAC; and/or physical layer protocols of the hybrid communication system comprise NR PHY protocols and/or PHY protocols. In some embodiments, DTT transport protocols of the hybrid communication system comprise MTS/ROUTE/MMTP; radio link layer protocols of the hybrid communication system comprise ALP/MPE/GSE/ULE protocols and/or physical layer pipe/MPEG transport streaming/GSE-L2 baseband physical framing protocols. This can enhance the data plane and control plane signaling and protocols of the one or more content delivery broadcasting systems for such interconnections and service delivery.

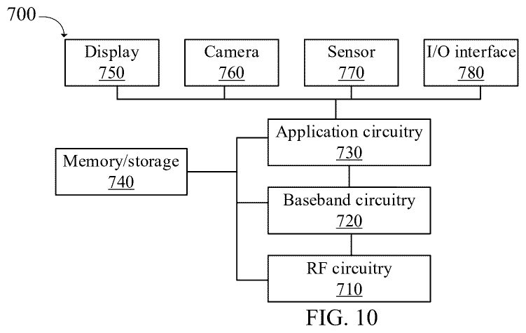

FIG. 10 is a block diagram of an example system 700 for wireless device according to an embodiment of the present disclosure. Embodiments described herein may be implemented into the system using any suitably configured hardware and/or software. FIG. 10 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single core or multi core processors. The processors may include any combination of general purpose processors and dedicated processors, such as graphics processors, application processors. The processors may be coupled with the memory/storage and configured to execute instructions stored in the memory/storage to enable various applications and/or operating systems running on the system.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

### Embodiment 7: The Acronym Presented in the Embodiments of the Present Disclosure are as Follows

GTP: GPRS Tunneling Protocol
NID: Network Identifier
MRB: MBS Radio Bearer
DRB: Data Radio Bearer
LLS: Link layer Signalling
LLC: Logical Link Control LLC
SIT: Selection Information Table
NIT: Network information Table
CSA: Common Scrambling Algorithm
CNEC: Common Encryption
EME: Encrypted Media Extensions
PLP: Physical Layer Pipe
LMT: Link Mapping Table
LLS: Low Level Signaling
SLS: Service Layer Signaling
S-TSID: Service-based Transport Session Instance Description
USBD: User Service Bundle Description
MPD: DASH Media Presentation Description
DIT: Discontinuity Information Table
EIT: Event Information Table
PAT: Programmed Association Table
MPE: Multiprotocol Encapsulation
ULE: Unidirectional Lightweight Encapsulation
GRE: Generic Routing Encapsulation
GSE: Generic Stream Encapsulation
TSDT: Transport Stream Descriptor Table
CAT: Conditional Access Table
PDCP: Packet Data Convergence Protocol
SDAP: Service Data Adaptation Protocol
RLC: Radio Link Control
MAC: Media Access Control
PLP: Physical Layer Pipe
ALP: ATSC Link-Layer Protocol
MTS: Multicast Transport Session
DASH: Dynamic Adaptive Streaming over HTTP
ROUTE: Real-time Object delivery over Unidirectional Transport
MMTP: MPEG Media Transport protocol
FLUTE: File Delivery over Unidirectional Transport
MPEG-TS: Moving Picture Experts Group Transport Stream
RRC: Radio Resource Control.

1. A hybrid communication system, comprising:
a user wireless device and one or more content delivery broadcasting systems, wherein the hybrid communication system and the user wireless device are configured for unicast, multicast and/or broadcast service data delivery over or reception from the one or more content delivery broadcasting systems, and the hybrid communication system comprises:
a joint content delivery network entity interconnected with an enhanced user plane function (UPF) entity and/or a multicast server entity over a first network interface and/or a second network interface; wherein the UPF entity or the multicast server entity is interconnected to an access network entity or to a non-access network entity via a third network interface and/or a fourth network interface; wherein the access network entity or the non-access network entity is linked via a first wireless interface and/or a second wireless interface to a wireless device through an intermediate radio access entity associated with the at least one of the content delivery broadcasting systems.

2. The hybrid communication system according to claim 1, wherein the hybrid communication system is configured to execute:
multiplexing and/or mapping by at least one network entity, an application layer service data type of a first broadcasting system onto a session type of a second broadcasting system and vice versa, and/or;
multiplexing and/or mapping of a session type of a first system onto common or individual tunneling protocol units of a second system and vice versa, and/or;
multiplexing and/or mapping of per-session common/individual tunneling protocol data units of the first system onto common or individual radio bearers, transport blocks, radio blocks or forwarding channels of the second system and vice versa.

3. The hybrid communication system according to claim 1, wherein the hybrid communication system is configured to execute:
providing by the at least one network entity, a signaling information and indication to the wireless device to a next hop network entity towards the wireless device via at least one interface to next hop to assist the network entity or the wireless device to distinguish between the service multiplex and apply a proper forwarding treatment and/or effectively receive the content service multiplex provided by at least one of the content delivery broadcasting systems.

4. The hybrid communication system according to claim 1, wherein a first system of the at least one of the content delivery broadcasting systems is a multicast and broadcast service (MBS) broadcasting system, and a second system of the at least one of the content delivery broadcasting systems is a digital terrestrial TV (DTT) broadcasting system and vice versa, wherein the DTT broadcasting system comprises at least one of a digital video broadcasting-terrestrial (DVB-T) system, an integrated services digital broadcasting (ISDB) system, a digital terrestrial multimedia broadcasting (DTMB) system, and/or an advanced television systems committee (ATSC) broadcasting system.

5. The hybrid communication system according to claim 3, wherein the application layer service data type of the first broadcasting system or the second broadcasting system is a category and/or indication of a service.

6. The hybrid communication system according to claim 5, wherein the category and/or indication of the service is defined in 3GPP MBS, DVB, DTMB and/or ATSC standards.

7. The hybrid communication system according to claim 5, wherein the category and/or indication of the service comprises a service identity or temporary mobile group identity (TMGI) of a service in case of the MBS broadcasting system.

8. The hybrid communication system according to claim 5, wherein the category and/or indication of the service comprises a service to a category identity mapping in case of the DTT broadcasting system.

9. The hybrid communication system according to claim 3, wherein the sessions type of the at least one of the content delivery broadcasting systems comprises an MBS session, a MPEG media transport protocol (MTP) session, a file delivery over unidirectional transport (FLUTE) session, a real-time object delivery over unidirectional transport ROUTE session, a multicast transport session (MTS) session and/or a combination thereof.

10. The hybrid communication system according to claim 3, wherein the mapping of per-session common/individual tunneling protocol data units of a first system onto common or individual radio bearers, transport blocks, radio blocks or forwarding channels of a second system, is based on transport, radio link layer and physical layer protocols of the at least one of the content delivery broadcasting systems.

11. The hybrid communication system according to claim 3, wherein the signaling information and indication to the wireless device or to the next hop network entity comprises a control plane signaling and/or a header within a user plane that is configured to determine a service within a service multiplex, and/or to provide an access information of a service, and/or to provide a scheduling description of a service.

12. The hybrid communication system communication method according to claim 11, wherein the access information of the service comprises a frequency, channels of services, and/or a security configuration for the service; and/or the service description comprises a start, an end and a scheduling information of the service.

13. The hybrid communication system according to claim 3, wherein the application layer service data type, the session type and/or the per-session common/individual tunneling protocol data units of the at least one of the content broadcasting systems is configured by the hybrid communication system to be received by the wireless device from the at least one of the content delivery broadcasting systems simultaneously or separately.

14. The hybrid communication system according to claim 3, wherein the non-access network entity is an anchor/gateway which terminates and maps a session type of the at least one of the content delivery broadcasting systems to per-session common/individual tunneling protocol data units and is delivered via an IP/IP multicast interface to either a gNodeB Distributed Unit (DU) radio access or a DTT radio access device, or a radio access device capable of employing both a lower layer radio protocol of stacks of the at least one of the content delivery broadcasting systems.

15. The hybrid communication system according to claim 3, wherein the access network entity is an enhanced gNode B Centralized Unit (CU) supporting mapping of per-session tunnel protocol data units provided by the enhanced UPF or multicast server via common GTP tunnels onto a radio bearer comprising a common multicast radio bearer (MRB) and/or a common PDCP entity in case of interconnecting with a gNB-DU access, or is mapped to ALP/MPE/GSE/ULE bearers in case of interconnecting with a DTT radio access.

16. The hybrid communication system according to claim 3, wherein the radio access entity is an entity employing layer 1 and layer 2 of the at least one of the content delivery broadcasting systems comprising data link layer and physical layer protocols comprising PLP/MPEG-TS/ULE/MPE/GSE-L2 protocol and/or RLC, MAC physical layer protocols, wherein the radio access entity is responsible of framing and transmission of radio bearers, transport blocks, radio blocks of the at least one of the content delivery broadcasting systems.

17. The hybrid communication system according to claim 3, wherein the wireless device is a user equipment comprising a linear TV set, an HDTV set, a handset, and/or a tablet device employing a set of either NR RAN or DTT transport, radio link layer and physical layer protocols which allows it to be capable to receive a unicast, multicast or broadcast user data service transmitted/delivered over the at least one of the content delivery broadcasting systems separately or simultaneously.

18. The hybrid communication system according to claim 14, wherein a NR transport protocol of the hybrid communication system comprises SDAP and/or PDCP; a radio link layer protocol of the hybrid communication system comprises RLC and/or MAC; and/or physical layer protocols of the hybrid communication system comprise NR PHY protocols and/or PHY protocols.

19. (canceled)

20. A communication method, comprising:
multiplexing and/or mapping by at least one network entity, an application layer service data type of a first broadcasting system onto a session type of a second broadcasting system and vice versa, and/or;
multiplexing and/or mapping of a session type of a first system onto common or individual tunneling protocol units of a second system and vice versa, and/or;
multiplexing and/or mapping of per-session common/individual tunneling protocol data units of the first system onto common or individual radio bearers, transport blocks, radio blocks or forwarding channels of the second system and vice versa.

21. The communication method according to claim 20, wherein the communication method further comprises:
providing by the at least one network entity, a signaling information and indication to the wireless device to a next hop network entity towards the wireless device via at least one interface to next hop to assist the network entity or the wireless device to distinguish between the service multiplex and apply a proper forwarding treatment and/or effectively receive the content service multiplex provided by at least one of the content delivery broadcasting systems.

22-26. (canceled)
